(19) United States
(12) Patent Application Publication
(10) Pub. No.: US 2016/0158813 A1
(43) Pub. Date: Jun. 9, 2016

(54) CLEANING ASSEMBLY AND METHOD FOR A SHAFT

(71) Applicant: INDUSTRIES MAILHOT INC., Terrebonne (CA)

(72) Inventor: LUC MAINVILLE, JOLIETTE (CA)

(21) Appl. No.: 14/942,231

(22) Filed: Nov. 16, 2015

Related U.S. Application Data
(60) Provisional application No. 62/089,444, filed on Dec. 9, 2014.

(51) Int. Cl. B08B 9/023

(52) U.S. Cl. CPC B08B 9/023

(57) ABSTRACT

A method and a system for increasing resistance to wear of an tubular member of a telescopic cylinder comprising at least one tubular section with an open end and an opposite end closed by a cylinder head, the tubular section comprising an outer tubular member, an inner tubular member telescopically displaceable in the outer tubular member, and a shaver secured to an inner wall of the cylinder head, comprising using at least one of a cutting edge of the shaver having a round profile and/or an inner diameter of the shaver equal to an outer diameter of the inner tubular member; and/or a wear ring positioned between the shaver and a sealing ring of the cylinder head.

### CROSS REFERENCE TO RELATED APPLICATIONS

This application claims benefit of U.S. provisional application Ser. No. 62/089,444, filed on Dec. 9, 2014. All documents above are incorporated herein in their entirety by reference.

### FIELD OF THE INVENTION

The present invention relates to industrial telescoping cylinders. More specifically, the present invention is concerned with a cleaning assembly and method for a shaft.

### BACKGROUND OF THE INVENTION

Industrial telescopic cylinders may be exposed to a wide range of contaminants, especially when provided on refuse collection trucks or garbage compactors for example. In refuse collection trucks, organic or mineral substances tend to adhere and accumulate on exposed surfaces of the vehicles, such as surfaces of sections of cylinder heads of the telescoping cylinders, where they cook under the action of heat. Such substances stick to surfaces of the cylinder heads and result in rapid damages of the sealing joints thereof, which may result in premature spills and leaks.

Telescopic cylinders consist of a series of telescopically arranged tubular sections with a cap closing a first end of each section. A second end of each section is mounted with a two-piece cylinder head while an inner tubular member has a plunger pin eye which threads into the tube section. The cylinder heads are threadedly mounted to an outer wall at the second end of each section; they are provided with dynamic and static seal means for sealing and with scraper means for removing debris from a surface along which the dynamic seal means slidably contacts.

In garbage trucks, hydraulic cylinders may be submitted to large lateral forces, i.e. perpendicular to the axial thrust force of the cylinder, due to mechanical misalignment of the equipment or to the action of attached compactors for example which, cause wearing out of the surface roughness of the cylinders, which in turn reduces the operating time of the cylinders, as lubrication is reduced below an efficient lubrication, thereby reducing the life span of the cylinders.

There is still a need in the art for cleaning assembly and method for a shaft.

### SUMMARY OF THE INVENTION

More specifically, in accordance with the present invention, there is provided a telescopic cylinder comprising at least one tubular section with an open end and an opposite end closed by a cylinder head, the tubular section comprising an outer tubular member, an inner tubular member telescopically displaceable in the outer tubular member, and a shaver secured to an inner wall of the cylinder head; wherein the cylinder further comprises at least one of a cutting edge of the shaver having a round profile; an inner diameter of the shaver equal to an outer diameter of the inner tubular member; and a wear ring positioned between the shaver and a sealing ring of the cylinder head.

There is further provided a method for increasing resistance to wear of an tubular member of a telescopic cylinder comprising at least one tubular section with an open end and an opposite end closed by a cylinder head, the tubular section comprising an outer tubular member, an inner tubular member telescopically displaceable in the outer tubular member, and a shaver secured to an inner wall of the cylinder head, the method comprising providing at least one of: a cutting edge of the shaver having a round profile; an inner diameter of the shaver equal to an outer diameter of the inner tubular member; and a wear ring positioned between the shaver and a sealing ring of the cylinder head.

Other objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

In the appended drawings:

FIG. 1 is a partial longitudinal cross-sectional view of a tubular section of a telescopic cylinder according to an embodiment of an aspect of the present invention;

FIG. 2 is a side view of FIG. 1;

FIG. 3 is cross section of FIG. 2 along A-A;

FIG. 4 is a detail of a cylinder head according to an embodiment of an aspect of the present invention;

FIG. 5A show a detail of a cutting tip of a shaver of a cylinder head according to an embodiment of an aspect of the present invention;

FIG. 5B show a detail of a cutting tip of a shaver of a cylinder head according to an embodiment of an aspect of the present invention;

FIG. 5C show a detail of a cutting tip of a shaver of a cylinder head according to an embodiment of an aspect of the present invention;

FIG. 5D shows a shaver of a cylinder head according to an embodiment of an aspect of the present invention;

FIG. 5E is a section of FIG. 5D along A-A;

FIG. 6 show results of a comparative test of surface roughness of an inner tubular member of cylinders a) of the prior art; b) with a shaver having an inner diameter increased over of the prior art; c) with a shaver having an inner diameter increased over of the prior art, and a wear ring positioned upstream of the sealing ring according to an embodiment of an aspect of the present invention; d) in the case of a wear ring positioned between the shaver and the sealing ring and with a shaver having an inner diameter increased over of the prior art as well as a round cutting edge, according to an embodiment of an aspect of the present invention; and e) in the case of a wear ring positioned between the shaver and the sealing ring and with a shaver having an inner diameter increased over of the prior art as well as a round cutting edge and with an inner tubular member provided with a polymeric surface impregnation, according to an embodiment of an aspect of the present invention;

FIG. 7A shows an inner tubular section with a layer of paint on the outer surface thereof as a reference;

FIG. 7B shows the inner tubular section of FIG. 7A after 10 cycles with a cylinder of the prior art;

FIG. 7C shows the inner tubular section of FIG. 7A after 1 cycle with a cylinder provided with a wear ring positioned between the shaver and the sealing ring and with the shaver having an inner diameter increased over of the prior art as well as a round cutting edge according to an embodiment of an aspect of the present invention; and

FIG. 7D shows the inner tubular section of FIG. 7A after 10 cycles with a cylinder provided with a wear ring positioned between the shaver and the sealing ring and with the shaver having an inner diameter increased over of the prior art as well as a round cutting edge according to an embodiment of an aspect of the present invention.

### DESCRIPTION OF EMBODIMENTS OF THE INVENTION

For clarity purposes, the invention will be described in relation to a structure made of a series of series of tubular sections telescopically arranged in a tubular housing, each of the tubular sections having one end provided with a cylinder head, and comprising an inner tubular member telescopically displaceable in an outer tubular member respectively, such as a telescopic cylinder for example, intended for use in contaminated environments.

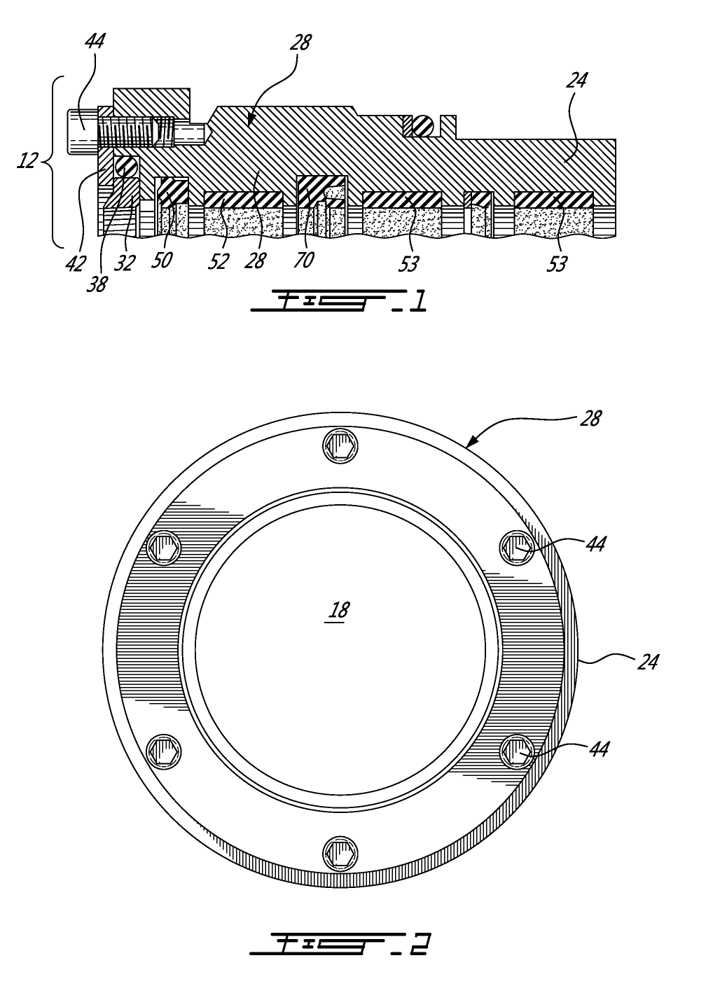

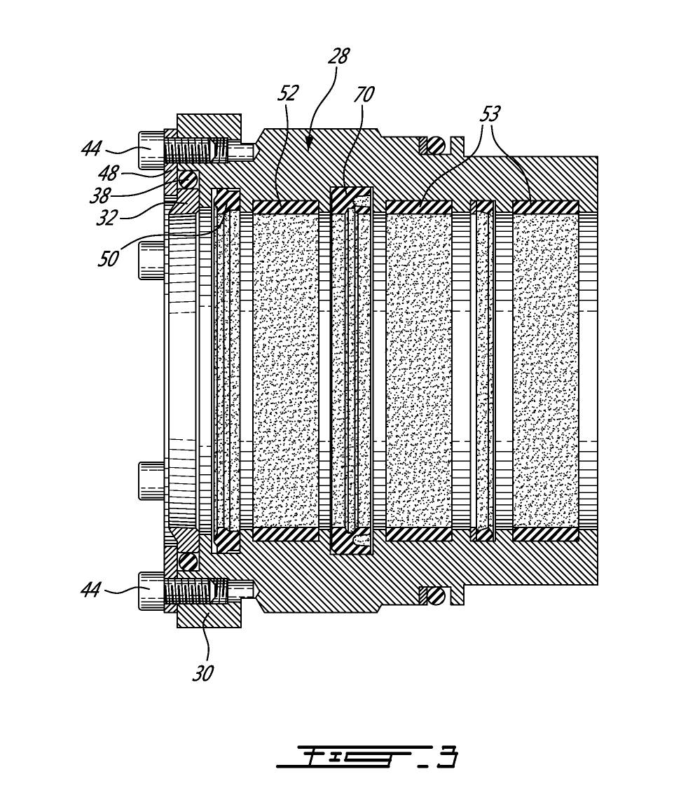

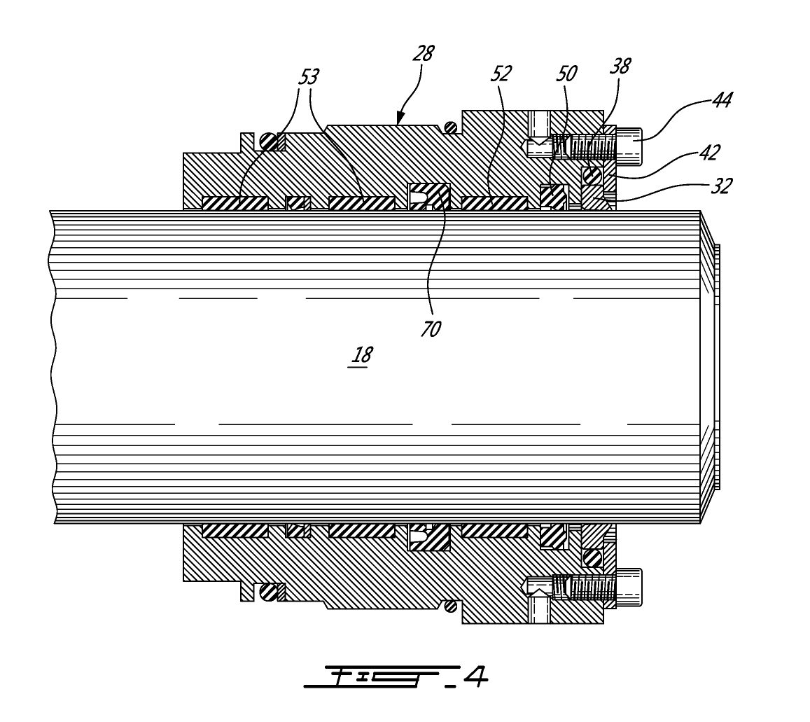

A telescopic cylinder may comprise a series of tubular sections 12, each tubular section comprising an inner tubular member 18 telescopically displaceable in an outer tubular member 24, with a wiper 50 mounted between the outer tubular member 24 and the inner tubular member 18. As illustrated for example in FIGS. 1-3, the tubular section 12 has one end provided with a cylinder head 28. The head 28 comprises a sealing ring 70 typically in a plastic material, urethane, or Teflon™ for example to prevent pressurized oil from leaking past the interface between the rod inner tubular member 18 and the head 20. As best seen in FIG. 3, the cylinder head 28 has an outer wall having an enlarged annular portion 30.

A shaver 32 is lodged in a corresponding circumferential recess in an inner wall of the cylinder head 28, with an O-ring 38. The shaver 32 is secured by a flange 42 against a lateral surface of the enlarged annular portion 30 of the cylinder head 28, for example by screws 44, so that the shaver 32 slides on an outer surface of the inner tubular member 18, thereby scraping contamination such as organic material or mineral material away from the outer surface of the inner tubular member 18. Wear rings 53 are positioned downstream of the sealing ring 70, away from the open end of the tubular arrangement.

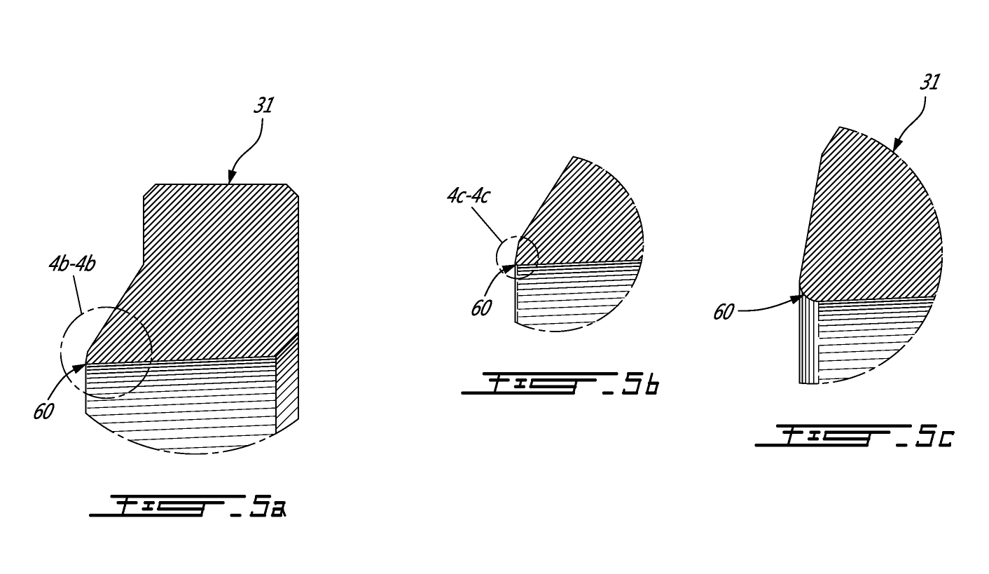

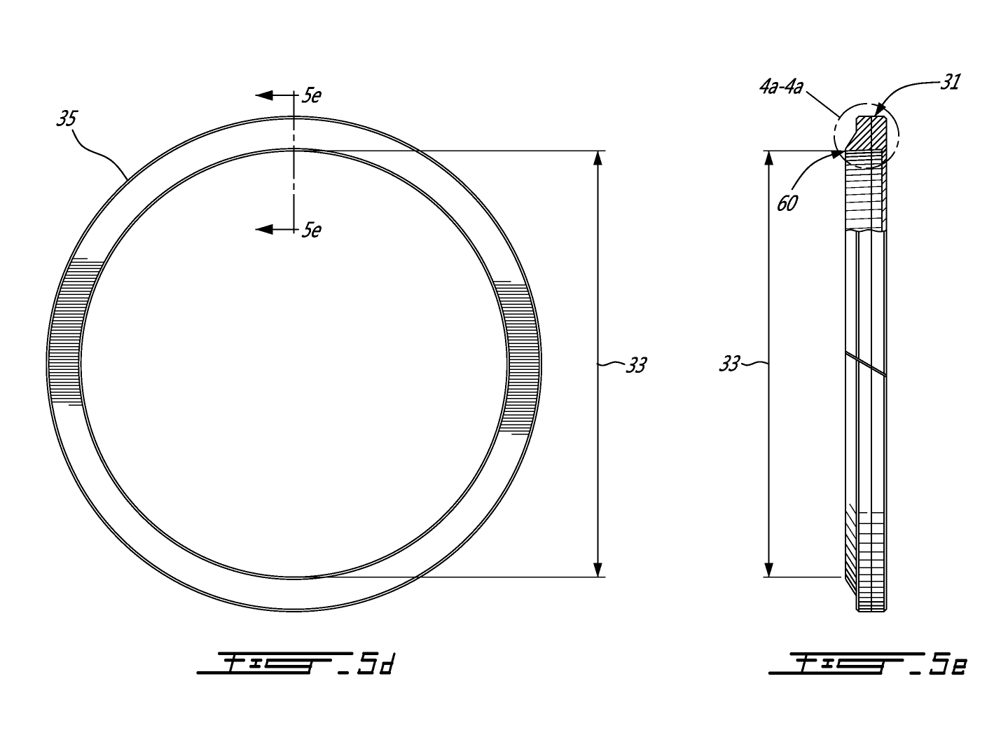

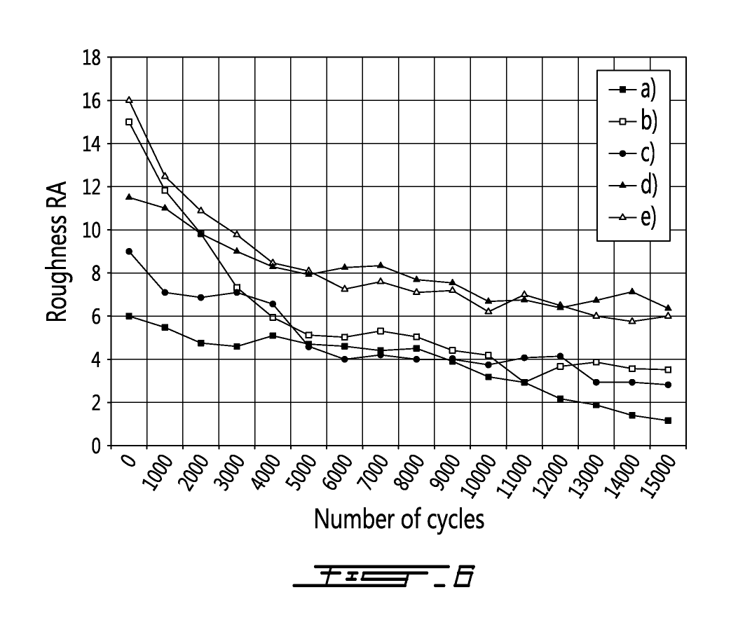

The cutting edge 60 of the shaver 32 is selected to have a round profile, i.e. a tip with a curvature radius, for example between 0.0002″ and 0.002″ (see FIG. 5C), which is found to reduce wearing out of the surface of the inner tubular member 18.

As shown in FIGS. 5D and 5E, the shaver 32 has an inner diameter 33 and an outer diameter 35. The inner diameter 33 of the shaver 32 is selected so that its inner diameter is substantially equal (+0.001″/−0.001″) to the outer diameter of the inner tubular member 18, as opposed to the prior art which taught using a shaver having an inner diameter smaller than the inner tubular member 18.

It is found that the inner diameter 33 of the shaver 32 close to the outer diameter of the inner tubular member 18 allows uniformity of the radial pressure submitted to the perimeter of the inner tubular member 18 by the shaver 32.

A wear ring 52 is positioned upstream of the sealing ring 70, i.e. between the shaver 32 and the sealing ring 70. The wear ring 52 takes over part of lateral loads applied on the cylinder, i.e. forces submitted generally perpendicularly to the longitudinal axis of the telescopic cylinder, stabilizes the cylinder head 28 and prevents excess pressure from the shaver 32 on the surface of the tubular member 18.

Each one of these features, i.e. the round shape of the edge of the shaver, the inner diameter 33 of the shaver 32 selected to match the outer diameter of the inner tubular member 18, and the wear ring 52 positioned upstream of the sealing ring 70, can be provided independently or in combination 2 by 2 or the three of them together. Each one of them is found to allow reducing the wear of the surface of the inner tubular member 18 over time, i.e. contribute to maintain the surface roughness RA of the inner tubular member over time.

For example, the round profile of the cutting edge 60 of the shaver 32 can be provided independently to improve the uniformity of the scrapping action and the uniformity of the radial pressure submitted to the surface of the inner tubular member 18 by the shaver 32.

FIG. 6 show results of comparative tests of surface roughness of inner tubular members of cylinders a) of the prior art; b) with a shaver having an inner diameter increased over of the prior art; c) with a shaver having an inner diameter increased over of the prior art, and the wear ring 52 positioned upstream of the sealing ring 70 between the shaver 32 and the sealing ring 70; d) in the case of a wear ring positioned between the shaver and the sealing ring and with a shaver having an inner diameter increased over of the prior art as well as a round cutting edge, and e) in the case of a wear ring positioned between the shaver and the sealing ring and with a shaver having an inner diameter increased over of the prior art as well as a round cutting edge, and with an inner tubular member provided with a polymeric surface impregnation, provided as anticorrosion layer.

The combination of i) the wear ring 52 positioned upstream of the sealing ring 70, i.e. between the shaver 32 and the sealing ring 70, and of ii) the inner diameter of the shaver 32 selected to be as close as possible to the outer diameter of the inner tubular member 18 (see graph c of FIG. 6) yields an optimized and maintained surface roughness, i.e. of about 4 Ra, of the inner tubular member 18 over time.

The combination of i) the wear ring 52 positioned upstream of the sealing ring 70, i.e. between the shaver 32 and the sealing ring 70, of ii) the inner diameter of the shaver 32 as close as possible top the outer diameter of the inner tubular member 18 and of iii) the round cutting edge of the shaver 32 (see graph d of FIG. 6) yields an optimized and maintained surface roughness, i.e. above 6 Ra for example, of the inner tubular member 18 over time. A polymeric surface layer, used for resistance to corrosion, does not impact the performance of the combination (see graph e of FIG. 6).

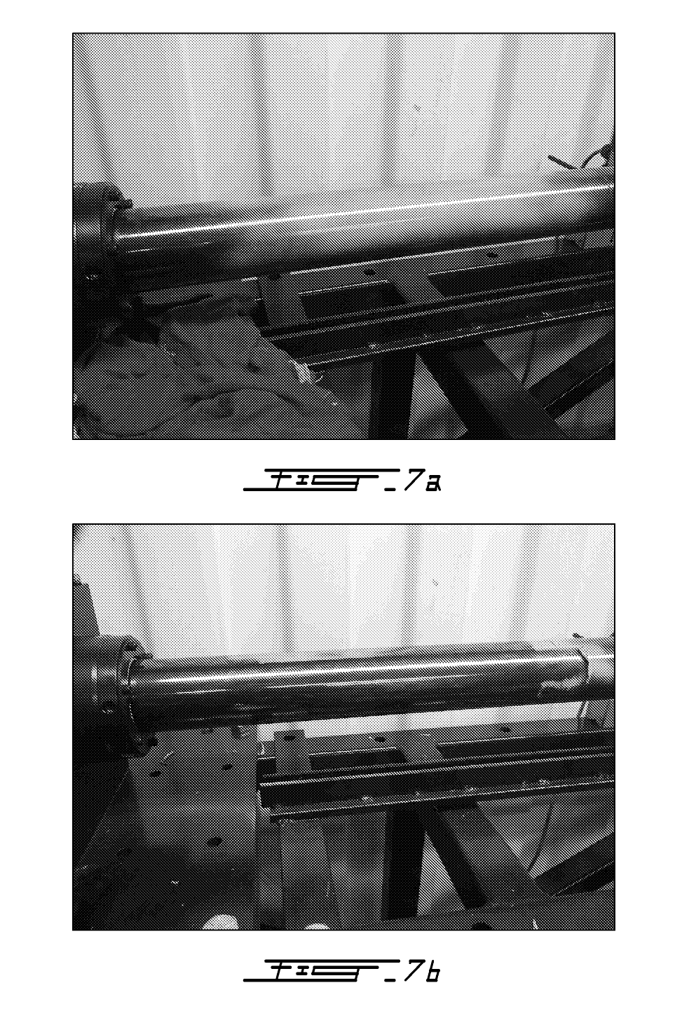

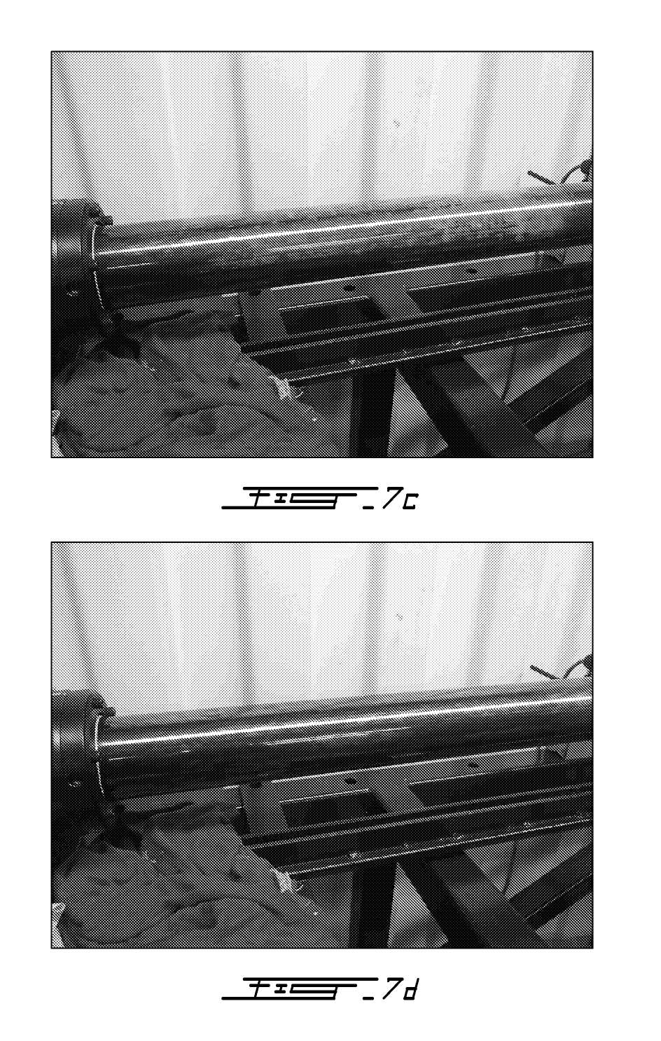

As illustrated in FIG. 7, such a shaver 32 proves to be very efficient in scrapping away cooked organic and mineral contaminants from the outer surface of tubular members, while reducing wearing out of the surface of the tubular members.

FIG. 7 show A) an inner tubular section with a layer of paint on the outer surface thereof as a reference; B) the inner tubular section after 10 cycles with a cylinder of the prior art; C) the inner tubular section after 1 cycle with a cylinder provided with a wear ring positioned between the shaver and the sealing ring and with the shaver having an inner diameter increased over of the prior art as well as a round cutting edge according to an embodiment of an aspect of the present invention; and D) the inner tubular section after 10 cycles with a cylinder provided with a wear ring positioned between the shaver and the sealing ring and with the shaver having an inner diameter increased over of the prior art as well as a round cutting edge according to an embodiment of an aspect of the present invention. The efficiency of paint removal is improved using a cylinder provided with a wear ring positioned between the shaver and the sealing ring and with the shaver having an increased inner diameter (see FIGS. 7C and 7D).

The shaver 32 is made in a material characterized by a hardness at least equal to the hardness of the inner tubular member 18. A material suitable for making cutting tools like a tool steel of a steel M2 type may be selected for the shaver 32. For example, for an inner tubular 18 hardness of 800 HV, a material having a hardness of 950 HV may be selected for the shaver 32.

Alternatively, for the shaver 32, a coated steel with a hard coating, i.e. a coating having a hardness at least equal to the hardness of the inner tubular member 18, for example of at least 800 HV hardness, and auto lubricating and anti-adhesive properties, such as D.L.C (Diamond Like Carbon), of a thickness in a range between 4 and 35 micrometers, may be used. DLC is known to have a small coefficient of friction and an excellent surface smoothness; the hardness of DLC is comprised between 3,500 and 4,000 HV, and its abrasion resistance, as measured by the rate of decrease of the surface roughness Ra for example, is excellent. DLC coatings are known for combining wear resistance, linked to hardness, and self-lubricating capacity. Other hard coatings, i.e. coatings of a hardness at least as high as the hardness of the inner tubular member 18 may be contemplated, such as Wc—Mo—Cr of hardness 1700 HV or Cr—C of hardness 1500 HV for example.

The pressure with which the shaver 32 is in contact with the outer surface of the inner tubular member is adjusted by controlling the compression of the O-ring 38, such as a nitrile O-ring joint, so that the pressure exerted by the blade on the outer surface of the inner tubular member 18 is at least 10 lb/inch².

The outer surface of the tubular member 18 to be cleaned may previously be submitted to a hardening treatment such as a nitriding treatment, so as to obtain a higher superficial hardness, i.e. a hardness in a range between 50 and 65 RC, i.e. between about 520 and 850 HV, over a thickness in a range between 10 and 30 micrometers and an increased surface lubrication capacity due to reduced friction, in such a way that a surface finish of the tubular member 18 may be further protected against an aggressive action of the shaver 32.

The present combination provides uniformity of the radial pressure submitted to the perimeter of the inner tubular member 18 by the shaver 32 and thereby reduces wearing off the surface roughness of the inner tubular member 18 while efficiently scrapping away contaminants from the outer surface of the tubular member 18.

The scope of the claims should not be limited by the preferred embodiments set forth in the examples, but should be given the broadest interpretation consistent with the description as a whole.

1. A telescopic cylinder comprising at least one tubular section with an open end and an opposite end closed by a cylinder head, the tubular section comprising an outer tubular member, an inner tubular member telescopically displaceable in said outer tubular member, and a shaver secured to an inner wall of the cylinder head; wherein said cylinder further comprises at least one of:
i) a cutting edge of the shaver having a round profile;
ii) an inner diameter of the shaver equal to an outer diameter of said inner tubular member; and
iii) a wear ring positioned between said shaver and a sealing ring of the cylinder head.

2. The telescopic cylinder of claim 1, comprising a wiper mounted between said outer tubular member and said inner tubular member, said sealing ring of the cylinder head being positioned downstream of said wiper.

3. The telescopic cylinder of claim 1, further comprising wear rings positioned downstream of the sealing ring of the cylinder head.

4. The telescopic cylinder of claim 1, wherein the cutting edge of the shaver has a round profile.

5. The telescopic cylinder of claim 1, wherein the inner diameter of the shaver is equal to the outer diameter of said inner tubular member.

6. The telescopic cylinder of claim 1, comprising a wear ring positioned between said shaver and the sealing ring of the cylinder head.

7. The telescopic cylinder of claim 1, wherein the cutting edge of the shaver has a round profile and the inner diameter of the shaver is equal to the outer diameter of said inner tubular member.

8. The telescopic cylinder of claim 1, comprising a wear ring positioned between said shaver and the sealing ring of the cylinder head and the cutting edge of the shaver having a round profile.

9. The telescopic cylinder of claim 1, comprising a wear ring positioned between said shaver and the sealing ring of the cylinder head and the inner diameter of the shaver being equal to the outer diameter of said inner tubular member.

10. The telescopic cylinder of claim 1, comprising a wear ring positioned between said shaver and the sealing ring of the cylinder head, the inner diameter of the shaver being equal to the outer diameter of said inner tubular member and the cutting edge of the shaver having a round profile.

11. The telescopic cylinder of claim 1, wherein the cutting edge of the shaver has a curvature radius comprised in a range between 0.0002″ and 0.002″.

12. The telescopic cylinder of claim 1, wherein said shaver has a surface hardness at least equal to a hardness of the surface of the inner tubular member.

13. A method for increasing resistance to wear of an tubular member of a telescopic cylinder comprising at least one tubular section with an open end and an opposite end closed by a cylinder head, the tubular section comprising an outer tubular member, an inner tubular member telescopically displaceable in the outer tubular member, and a shaver secured to an inner wall of the cylinder head, the method comprising providing at least one of:
i) a cutting edge of the shaver having a round profile;
ii) an inner diameter of the shaver equal to an outer diameter of the inner tubular member; and
iii) a wear ring positioned between the shaver and a sealing ring of the cylinder head.

14. The method of claim 13, comprising providing a cutting edge of the shaver having a round profile, with a curvature radius comprised in a range between 0.0002″ and 0.002″.

15. The method of claim 13, comprising selecting a shaver having a surface hardness at least equal to a hardness of the surface of the inner tubular member.
